(19) United States
(12) Patent Application Publication
(10) Pub. No.: US 2021/0089173 A1
(43) Pub. Date: Mar. 25, 2021

(54) ELECTRONIC DEVICE AND METHOD FOR CHANGING USER INTERFACE ACCORDING TO USER INPUT

(71) Applicant: SAMSUNG ELECTRONICS CO., LTD., Suwon-si (KR)

(72) Inventors: Jonghyun HAN, Suwon-si (KR); Youngil OH, Suwon-si (KR); Yejin KIM, Suwon-si (KR); Haeree NA, Suwon-si (KR); Jihyun AHN, Suwon-si (KR); Youngmin YOON, Suwon-si (KR)

(21) Appl. No.: 17/025,308

(22) Filed: Sep. 18, 2020

(30) Foreign Application Priority Data
Sep. 19, 2019 (KR) 10-2019-0115500

(51) Int. Cl. G06F 3/0481; G06F 3/0485

(52) U.S. Cl. CPC G06F 3/0481; G06F 3/0485

(57) ABSTRACT

An electronic device according to an embodiment may include: a flexible display; at least one sensor; a processor; and a memory operatively coupled to the flexible display, the at least one sensor, and the processor. The memory may store instructions that, when executed, cause the processor to control the electronic device to: display at least one content in a visible area among display areas of the flexible display; identify an input regarding a first content of the at least one content based on the visible area of the flexible display being changed using the at least one sensor; and change a layout regarding the first content identified by the input in the changed visible area of the flexible display in response to identifying the input.

### CROSS-REFERENCE TO RELATED APPLICATION

This application is based on and claims priority under 35 U.S.C. § 119 to Korean Patent Application No. 10-2019-0115500, filed on Sep. 19, 2019, in the Korean Intellectual Property Office, the disclosure of which is incorporated by reference herein in its entirety.

### BACKGROUND

### Field

The disclosure relates to an electronic device and a method for changing a user interface according to a user input.

### Description of Related Art

An electronic device may include a flexible display. The area of the electronic device, which is visible to the user, may be changed according to the state of the flexible display (for example, rolled state, intermediate state, or unrolled state).

An electronic device including a flexible display may change the user interface displayed through the display if the display switches from a first state to a second state. By changing the user interface, the electronic device may display more contents to the user.

However, if interaction with the user is not considered when changing the user interface, the electronic device may fail to provide a user interface conforming to the user's intent.

The above information is presented as background information only to assist with an understanding of the disclosure. No determination has been made, and no assertion is made, as to whether any of the above might be applicable as prior art with regard to the disclosure.

### SUMMARY

Embodiments of the disclosure provide an electronic device and a method that may advantageously provide a user interface conforming to the user's intent by changing the user interface in view of the user's interaction when the display is extended or reduced.

The technical aspects of the disclosure are not limited to the above mentioned technical subjects, and other technical aspects which are not mentioned may be clearly understood, through the following descriptions by those skilled in the art to which the disclosure pertains.

An electronic device according to an example embodiment may include: a flexible display; at least one sensor; a processor; and a memory operatively coupled to the flexible display, the at least one sensor, and the processor. The memory may store instructions that, when executed, cause the processor to control the electronic device to: display at least one content in a visible area among display areas of the flexible display; identify an input regarding a first content of the at least one content based on the visible area of the flexible display being changed, using the at least one sensor; and change a layout regarding the first content identified by the input in the changed visible area of the flexible display in response to identifying the input.

A method for operating an electronic device according to an example embodiment may include: displaying at least one content in a visible area among display areas of a flexible display of the electronic device; identifying an input regarding a first content of the at least one content based on the visible area of the flexible display being changed using at least one sensor of the electronic device; and changing a layout regarding the first content identified by the input in the changed visible area of the flexible display in response to identifying the input.

An electronic device and a method according to an embodiment may advantageously provide a user interface conforming to the user's intent by differently changing the user interface in view of the user's interaction when the display is extended or reduced.

Effects obtainable from the disclosure are not be limited to the above mentioned effects, and other effects not specifically mentioned may be clearly understood through the following descriptions by those skilled in the art.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram illustrating an example electronic device in a network environment according to an embodiment;

FIG. 2A is a diagram illustrating example changes in a visible area of a display of an electronic device according to an embodiment;

FIG. 2B is a diagram illustrating example changes in a visible area of a display of an electronic device according to an embodiment;

FIG. 2C is a diagram illustrating example changes in a visible area of a display of an electronic device according to an embodiment;

FIG. 3A is a diagram illustrating an example change in a user interface resulting from extension of a visible area of a display of an electronic device according to an embodiment;

FIG. 3B is a diagram illustrating an example change in a user interface resulting from extension of a visible area of a display of an electronic device according to an embodiment;

FIG. 4A is a diagram illustrating an example change in a user interface resulting from extension of a visible area of a display of an electronic device according to an embodiment;

FIG. 4B is a diagram illustrating an example change in a user interface resulting from extension of a visible area of a display of an electronic device according to an embodiment;

FIG. 5A is a diagram illustrating an example change in a user interface for a video call resulting from extension of a visible area of a display of an electronic device according to an embodiment;

FIG. 5B is a diagram illustrating an example change in a user interface for a video call resulting from extension of a visible area of a display of an electronic device according to an embodiment;

FIG. 6A is a diagram illustrating an example change in a user interface for a video call resulting from a change in a visible area of a display of an electronic device according to an embodiment;

FIG. 6B is a diagram illustrating an example change in a user interface for a video call resulting from a change in a visible area of a display of an electronic device according to an embodiment;

FIG. 7A is a diagram illustrating an example change in a user interface of applications resulting from extension of a visible area of a display of an electronic device according to an embodiment;

FIG. 7B is a diagram illustrating an example change in a user interface of applications resulting from extension of a visible area of a display of an electronic device according to an embodiment;

FIG. 8A is a diagram illustrating an example change in a user interface of applications resulting from extension of a visible area of a display of an electronic device according to an embodiment;

FIG. 8B is a diagram illustrating an example change in a user interface of applications resulting from extension of a visible area of a display of an electronic device according to an embodiment;

FIG. 9A is a diagram illustrating an example change in a user interface for a notification resulting from extension of a visible area of a display of an electronic device according to an embodiment;

FIG. 9B is a diagram illustrating an example change in a user interface for a notification resulting from extension of a visible area of a display of an electronic device according to an embodiment;

FIG. 10A is a diagram illustrating an example change in a user interface for a notification resulting from extension of a visible area of a display of an electronic device according to an embodiment;

FIG. 10B is a diagram illustrating an example change in a user interface for a notification resulting from extension of a visible area of a display of an electronic device according to an embodiment;

FIG. 11A is a diagram illustrating an example change in a user interface for a notification resulting from extension of a visible area of a display of an electronic device according to an embodiment;

FIG. 11B is a diagram illustrating an example change in a user interface for a notification resulting from extension of a visible area of a display of an electronic device according to an embodiment;

FIG. 12A is a diagram illustrating an example of switching of a screen resulting from extension of a visible area of a display of an electronic device according to an embodiment;

FIG. 12B is a diagram illustrating an example of switching of a screen resulting from extension of a visible area of a display of an electronic device according to an embodiment;

FIG. 13A is a diagram illustrating an example of switching of a screen resulting from extension of a visible area of a display of an electronic device according to an embodiment;

FIG. 13B is a diagram illustrating an example of switching of a screen resulting from extension of a visible area of a display of an electronic device according to an embodiment;

FIG. 14A is a diagram illustrating an example change in the recent home screen resulting from extension of a visible area of a display of an electronic device according to an embodiment;

FIG. 14B is a diagram illustrating an example change in the recent home screen resulting from extension of a visible area of a display of an electronic device according to an embodiment;

FIG. 15A is a diagram illustrating an example change in the recent home screen resulting from extension of a visible area of a display of an electronic device according to an embodiment;

FIG. 15B is a diagram illustrating an example change in the recent home screen resulting from extension of a visible area of a display of an electronic device according to an embodiment;

FIG. 16A is a diagram illustrating an example change in application execution screens resulting from extension of a visible area of a display of an electronic device according to an embodiment;

FIG. 16B is a diagram illustrating an example change in application execution screens resulting from extension of a visible area of a display of an electronic device according to an embodiment;

FIG. 17A is a diagram illustrating an example change in application execution screens resulting from extension of a visible area of a display of an electronic device according to an embodiment;

FIG. 17B is a diagram illustrating an example change in application execution screens resulting from extension of a visible area of a display of an electronic device according to an embodiment;

FIG. 18 is a flowchart illustrating example operations of an electronic device according to an embodiment;

FIG. 19A is a diagram illustrating an example change following the degree of unrolling of a display of an electronic device according to an embodiment;

FIG. 19B is a diagram illustrating an example change following the degree of unrolling of a display of an electronic device according to an embodiment;

FIG. 19C is a diagram illustrating an example change following the degree of unrolling of a display of an electronic device according to an embodiment;

FIG. 20A is a diagram illustrating an example change following the degree of unrolling of a display of an electronic device according to an embodiment;

FIG. 20B is a diagram illustrating an example change following the degree of unrolling of a display of an electronic device according to an embodiment;

FIG. 20C is a diagram illustrating an example change following the degree of unrolling of a display of an electronic device according to an embodiment;

FIG. 21A is a diagram illustrating an example change following the degree of unrolling of a display of an electronic device according to an embodiment;

FIG. 21B is a diagram illustrating an example change following the degree of unrolling of a display of an electronic device according to an embodiment; and

FIG. 21C is a diagram illustrating an example change following the degree of unrolling of a display of an electronic device according to an embodiment.

### DETAILED DESCRIPTION

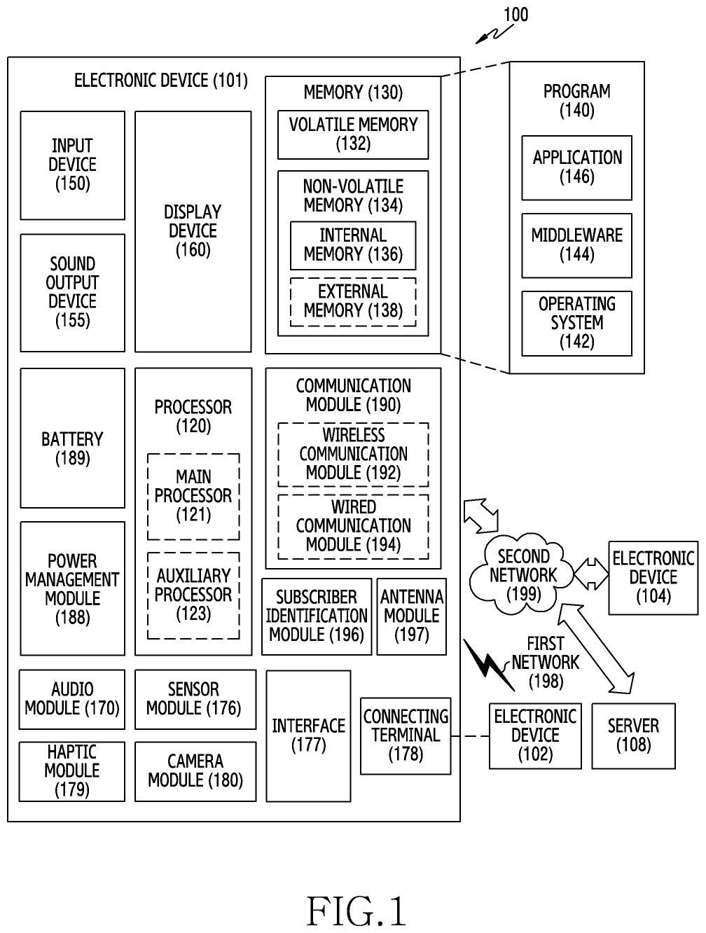

FIG. 1 is a block diagram illustrating an example electronic device 101 in a network environment 100 according to various embodiments.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to an example embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an example embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, and without limitation, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code made by a complier or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore^{Tm}), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

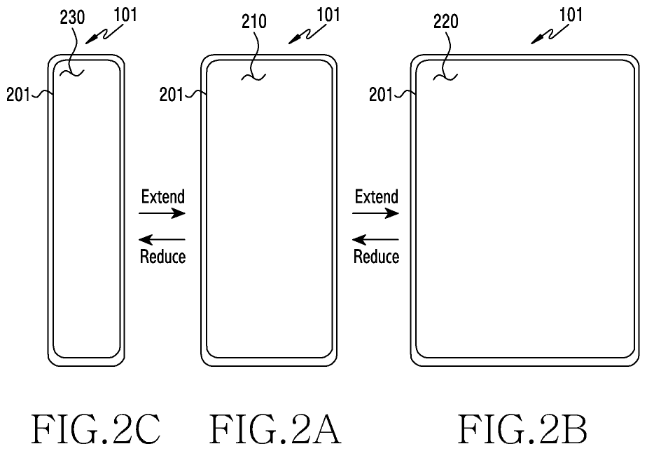

FIG. 2A is a diagram illustrating an example change in a visible area 210 of a display of an electronic device 101 according to an embodiment, FIG. 2B is a diagram illustrating an example change in a visible area 220 of a display of an electronic device 101 according to an embodiment, and FIG. 2C is a diagram illustrating an example change in a visible area 230 of a display of an electronic device 101 according to an embodiment. FIG. 2A, FIG. 2B, and FIG. 2C may be described with reference to the components in FIG. 1.

In an embodiment, the display 201 of the electronic device 101 in FIG. 2A, FIG. 2B, and FIG. 2C may, for example, be a rollable display.

Referring to FIG. 2A, FIG. 2B, and FIG. 2C, the visible areas 210, 220, 230 (which may be referred to herein as 210-230 for convenience) of the display 201 of the electronic device 101 may be changed. In an embodiment, the visible areas 210-230 of the display 201 of the electronic device 101 may be changed according to a structural change in the display 201 (or electronic device 101) (for example, the degree of winding of the display 201 or the degree of unrolling of the display 201). In an embodiment, the visible areas 210-230 of the display 201 may refer to areas that can be seen by the user, among display areas of the display 201. In an embodiment, the display areas of the display 201 may refer to areas in which light-emitting elements (for example, display panels) are provided, among the entire area of the display 201.

In an embodiment, FIG. 2A illustrates a visible area 210 when the display 201 of the electronic device 101 has an intermediate state. In an embodiment, FIG. 2B illustrates a visible area 220 when the display 201 of the electronic device 101 has an unrolled or expanded/extended state. In an embodiment, FIG. 2C illustrates a visible area 230 when the display 201 of the electronic device 101 has a rolled state or reduced state. In an embodiment, the rolled state of the display 201 may refer to a state in which the display 201 is rolled to the largest extent. In an embodiment, the unrolled state of the display 201 may refer to a state in which the display 201 is unrolled to the largest extent. In an embodiment, the intermediate state of the display 201 may refer to a state in which a part of the display 201 is rolled, while the remaining part thereof is unrolled. Although FIG. 2A, FIG. 2B, and FIG. 2C illustrates a single intermediate state in connection with the display 201, the same is only an example. In an embodiment, the display 201 of the electronic device 101 may have multiple intermediate states corresponding to the degrees of unrolling (or rolling) of the display 201.

In an embodiment, if the user grasps the right side of the electronic device 101 with the right hand and then pulls the same rightwards with the grasping hand, the display 201 of the electronic device 101 may be extended from the rolled state (or intermediate state) to the intermediate state (or unrolled state). In an embodiment, if the user grasps the left side of the electronic device 101 with the left hand and then pulls the same leftwards with the grasping hand, the display 201 of the electronic device 101 may be extended from the rolled state (or intermediate state) to the intermediate state (or unrolled state). In an embodiment, if the user applies a user input intended to unroll the display 201, the electronic device 101 may extend the display 201 from the rolled state (or intermediate state) to the intermediate state (or unrolled state). In an embodiment, in order to change the state of the display 201 based on a user input, the electronic device 101 may include an actuator for changing the state of the display 201, a motor, or a combination thereof.

In an embodiment, if the user grasps the right side of the electronic device 101 with the right hand and then pushes the same leftwards with the grasping hand, the display 201 of the electronic device 101 may be reduced from the intermediate state (or unrolled state)) to the rolled state (or intermediate state). In an embodiment, if the user grasps the left side of the electronic device 101 with the left hand and then pushes the same rightwards with the grasping hand, the display 201 of the electronic device 101 may be reduced from the intermediate state (or unrolled state)) to the rolled state (or intermediate state). In an embodiment, if the user applies a user input intended to roll the display 201, the electronic device 101 may reduce the display 201 from the intermediate state (or unrolled state) to the rolled state (or intermediate state).

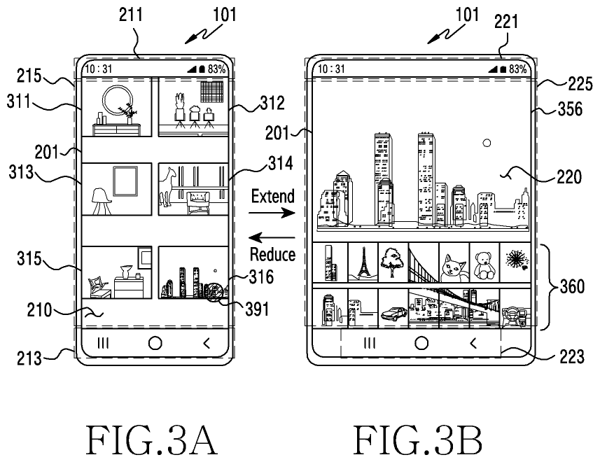

FIG. 3A is a diagram illustrating an example change in a user interface resulting from extension of a visible area of a display 201 of an electronic device 101 according to an embodiment, and FIG. 3B is a diagram illustrating an example change in a user interface resulting from extension of a visible area of a display 201 of an electronic device 101 according to an embodiment. FIG. 3A and FIG. 3B may be described with reference to the components in FIG. 1.

Referring to FIG. 3A, the display 201 may display user interfaces 211, 213, and 215 in a visible area 210. Referring to FIG. 3A, the display 201 may be in an intermediate state.

Referring to FIG. 3B, the display 201 may display user interfaces 221, 223, and 225 in a visible area 220. In an embodiment, the user interfaces 221 and 223 may be user interfaces extended from the user interfaces 211 and 213, respectively. In an embodiment, the user interface 225 and the user interface 215 may be execution screens of the same application. Referring to FIG. 3B, the display 201 may be in an unrolled state. However, this is only an example, and the display 201 in FIG. 3Bmay be in an intermediate state in which the same is unrolled slightly more than the display 201 in FIG. 3A.

Referring to FIG. 3A and FIG. 3B, if the electronic device 101 is extended while user interfaces 211, 213, and 215 are displayed in the visible area 210, user interfaces 221, 223, and 225 corresponding to the extended visible area 220 may be displayed. Referring to FIG. 3A and FIG. 3B, if the electronic device 101 is reduced while user interfaces 221, 223, and 225 are displayed in the visible area 220, the user interfaces 211, 213, and 215 may be displayed in the reduced visible area 210.

Although example visible areas 210 and 220 having two sizes are illustrated in FIG. 3, these are only examples. In an embodiment, there may exist, on the display 201 of the electronic device 101, visible areas having multiple sizes between the size of the visible area 210 and the size of the visible area 220. Therefore, there may exist multiple user interfaces displayed in visible areas having multiple sizes, between the user interface 211 displayed in the visible area 210 and the user interface 221 displayed in the visible area 220. In addition, there may exist multiple user interfaces displayed in visible areas having multiple sizes, between the user interface 213 displayed in the visible area 210 and the user interface 223 displayed in the visible area 220. In addition, there may exist multiple user interfaces displayed in visible areas having multiple sizes, between the user interface 215 displayed in the visible area 210 and the user interface 225 displayed in the visible area 220. In addition, the multiple user interfaces displayed in the visible areas having multiple sizes may be user interfaces for continuity between the user interface 211 and the user interface 221. In addition, the multiple user interfaces displayed in the visible areas having multiple sizes may be user interfaces for continuity between the user interface 213 and the user interface 223. In addition, the multiple user interfaces displayed in the visible areas having multiple sizes may be user interfaces for continuity between the user interface 215 and the user interface 225.

In an embodiment, the user interfaces 211 and 221 may be status bars for providing the user with situation information. In an embodiment, the user interfaces 211 and 221 may include a digital watch for providing the user visual information. In an embodiment, the user interfaces 211 and 221 may include an icon for providing the user with communication signal intensity information. In an embodiment, the user interfaces 211 and 221 may include an icon for providing the user with information regarding the power level of the battery of the electronic device 101.

In an embodiment, the user interfaces 213 and 223 may be navigation bars providing a key function. In an embodiment, the user interfaces 213 and 223 may include an icon for providing a function of switching to the home screen. In an embodiment, the user interfaces 213 and 223 may include an icon for providing a function of switching to the latest app screen. In an embodiment, the user interfaces 213 and 223 may include an icon for providing a move back function.

In an embodiment, the electronic device 101 may display contents (for example, a text, a still image, a moving image, or a combination thereof) to the user through user interfaces 215 and 225. In an embodiment, the user interfaces 215 and 225 may represent execution screens of an application (for example, gallery application).

In an embodiment, the user interface 215 may have a layout configured such that multiple pictures 311-316 are disposed with the same size.

In an embodiment, the user may manipulate the electronic device 101 in order to extend the visible area 210 of the display 201. In an embodiment, if the user manipulates the electronic device 101 in order to extend the visible area 210 of the display 201, the processor (for example, processor 120 in FIG. 1) may identify a change in the visible area 210. In an embodiment, the user may apply a press input 391 on the display 201. In an embodiment, if the user applies a press input on the display 201, the processor 120 may identify the press input 391 regarding specific content (for example, picture 316) on the display 201.

In an embodiment, the timepoint at which the user manipulates the electronic device 101 in order to extend the visible area 210 of the display 201 and the timepoint at which the user applies the press input 391 on the display 201 may at least partially overlap. In an embodiment, the user may apply the press input 391 on the display 201 while manipulating the electronic device 101 in order to extend the visible area 210 of electronic device 101. In an embodiment, the user may manipulate the electronic device 101 in order to extend the visible area 210 of the electronic device 101 while applying the press input 391 on the display 201.

In an embodiment, upon identifying a change in the visible area 210 and a press input 391 regarding specific content (for example, picture 316), the processor 120 may change the layout regarding the specific content (for example, picture 316) indicated by the press input 391. In an embodiment, upon identifying a change in the visible area 210 and a press input 391 regarding specific content (for example, picture 316), the processor 120 may extend a user interface (for example, user interface 215) with reference to the specific content (for example, picture 316) indicated by the press input 391, and may display the extended user interface (for example, user interface 225) in a changed visible area 220.

In an embodiment, the processor 120 may display, in the visible area 220, a user interface 225 having a layout configured such that, among multiple pictures 356 and 360, the picture 356 corresponding to the press input 391 is disposed with an extended size compared with the other pictures 360. In an embodiment, the picture 356 may be an extended version of the picture 316.

In an embodiment, the processor 120 may change the size of the picture 316 corresponding to the press input 391, based on the rate of change of a visible area (for example, rate of change between visible area 220 and visible area 210). In an embodiment, the processor 120 may display a changed picture 356 in the visible area 220, based on the rate of change of a visible area. In an embodiment, the aspect ratio of the picture 356 may be identical to the aspect ratio of the picture 316.

In an embodiment, the processor 120 may display, in the visible area 220, a user interface 225 extended to have a layout configured such that the width of the picture 356 corresponding to the press input 391 corresponds to the width of the visible area 220 (or the length along the direction of extension of the display 201). In an embodiment, the processor 120 may display, in the visible area 220, a user interface 225 extended to have a layout configured such that the picture 356 corresponding to the press input 391 is positioned in a predesignated position in the area of the user interface 225 (for example, at the upper end of the user interface 225).

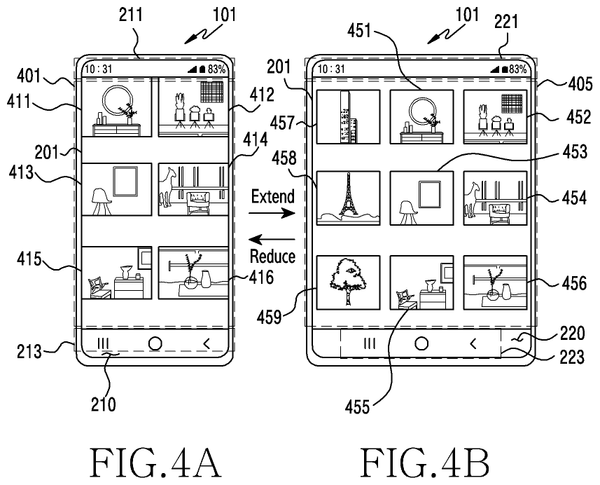

FIG. 4A is a diagram illustrating an example change in a user interface resulting from extension of a visible area of a display 201 of an electronic device 101 according to an embodiment, and FIG. 4B is a diagram illustrating an example change in a user interface resulting from extension of a visible area of a display 201 of an electronic device 101 according to an embodiment. FIG. 4A and FIG. 4B may be described with reference to the components in FIG. 1.

Referring to FIG. 4A, the display 201 may display user interfaces 211, 213, and 401 in a visible area 210. In an embodiment, the user interfaces 211, 213, and 401 in FIG. 4A may correspond to the user interfaces 211, 213, and 215 in FIG. 3A, respectively. Referring to FIG. 4A, the display 201 may be in an intermediate state.

Referring to FIG. 4B, the display 201 may display user interfaces 221, 223, and 405 corresponding to the size of the visible area 220. In an embodiment, the user interfaces 221, 223, and 405 may be user interfaces extended from the user interfaces 211, 213, and 401, respectively. In an embodiment, the user interfaces 221 and 223 in FIG. 4B may correspond to the user interfaces 221 and 223 in FIG. 3B, respectively. Referring to FIG. 4B, the display 201 may be in an unrolled state. However, this is only an example, and the display 201 in FIG. 4B may be in an intermediate state in which the same is unrolled slightly more than the display 201 in FIG. 4A.

In an embodiment, the electronic device 101 may display contents (for example, a text, a still image, a moving image, or a combination thereof) to the user through user interfaces 401 and 405. In an embodiment, the user interfaces 401 and 405 may represent execution screens of an application (for example, gallery application).

In an embodiment, the user interface 401 may have a layout configured such that multiple pictures 411-416 are disposed with the same size. In an embodiment, the multiple pictures 411-416 may be displayed with predesignated picture sizes, respectively, in the user interface 401.

In an embodiment, the user may manipulate the electronic device 101 in order to extend the visible area 210 of the display 201. In an embodiment, if the user manipulates the electronic device 101 in order to extend the visible area 210 of the display 201, the processor (for example, processor 120 in FIG. 1) may identify a change in the visible area 210. In an embodiment, the user may apply no press input on the display 201 while the user manipulates the electronic device 101 in order to extend the visible area 210 of the display 201. In an embodiment, if the user applies no press input on the display 201, no press input regarding specific content on the display 201 may be transmitted to the processor 120.

In an embodiment, if a change in the visible area 210 is identified with no press input regarding specific content, the processor 120 may extend a user interface (for example, user interface 401) and may display an extended user interface (for example, user interface 405) in a changed visible area 220.

In an embodiment, the user interface 405 may display a larger number of pictures 451-459 than the user interface 401. Although FIG. 4A and FIG. 4B illustrate an example case in which, as the visible area 210 is extended to the visible area 220, the user interface 405 displays more pictures 457-459 than the user interface 401, this is only an example. In an embodiment, as the visible area 210 is extended to the visible area 220, the user interface 405 may enlarge and display the same number of pictures as the user interface 401.

Referring to FIG. 3A, FIG. 3B, FIG. 4A, and FIG. 4B, according to whether or not a press input 391 is identified while the visible area 210 is extended, the processor 120 may change the layout of the user interface 215 with reference to the content (for example, picture 316) corresponding to the press input 391, or may extend the user interface 401. In an embodiment, if a press input is identified while the visible area 210 is extended, the processor 120 may change the layout of the user interface 215 with reference to the content (for example, picture 316) corresponding to the press input 391 and, if no press input is identified while the visible area 210 is extended, may extend the user interface 401.

Although FIG. 3A, FIG. 3B, FIG. 4A, and FIG. 4B illustrate an example change in a user interface according to whether or not a press input is identified while a visible area 210 is extended, this is only an example. In an embodiment, according to whether or not a press input is identified while the visible area 210 is reduced, the layout of the user interface may be changed, or the user interface may be reduced. In an embodiment, if a press input is identified while the visible area 220 is reduced, the processor 120 may change the layout of the user interface with reference to the content corresponding to the press input. In an embodiment, if no press input is identified while the visible area 220 is reduced, the processor 120 may reduce the user interface. In an embodiment, the operation of reducing the user interface may be the opposite of the operation of extending the user interface.

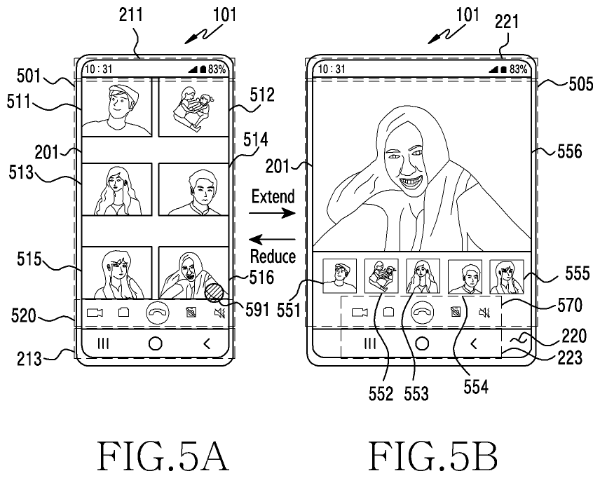

FIG. 5A is a diagram illustrating an example change in a user interface for a video call resulting from extension of a visible area of a display 201 of an electronic device 101 according to an embodiment, and FIG. 5B is a diagram illustrating an example change in a user interface for a video call resulting from extension of a visible area of a display 201 of an electronic device 101 according to an embodiment. FIG. 5A and FIG. 5B may be described with reference to the components in FIG. 1.

Referring to FIG. 5A, the display 201 may display user interfaces 211, 213, and 501 in a visible area 210. In an embodiment, the user interfaces 211 and 213 in FIG. 5A may correspond to the user interfaces 211 and 213 in FIG. 3A, respectively. Referring to FIG. 5A, the display 201 may be in an intermediate state.

Referring to FIG. 5B, the display 201 may display user interfaces 221, 223, and 505 corresponding to the size of the visible area 220. In an embodiment, the user interfaces 221 and 223 may be user interfaces extended from the user interfaces 211 and 213, respectively. In an embodiment, the user interface 505 and the user interface 501 may be execution screens of the same application. In an embodiment, the user interfaces 221 and 223 in FIG. 5B may correspond to the user interfaces 221 and 223 in FIG. 3B, respectively. Referring to FIG. 5B, the display 201 may be in an unrolled state. However, this is only an example, and the display 201 in FIG. 5B may be in an intermediate state in which the same is unrolled slightly more than the display 201 in FIG. 5A.

In an embodiment, the electronic device 101 may display images to the user through the user interfaces 501 and 505. In an embodiment, the user interfaces 501 and 505 may represent video call application execution screens. In an embodiment, the images displayed through the user interfaces 501 and 505 may be based on image data acquired through other electronic devices (for example, electronic devices 102 and 104).

In an embodiment, the user interfaces 501 and 505 may include bars 520 and 570 for manipulating the video call, respectively. In an embodiment, the bars 520 and 570 for manipulating the video call may include an icon for ending the video call.

In an embodiment, the user interface 501 may have a layout configured such that multiple images 511-516 are disposed with the same size.

In an embodiment, upon identifying a change in the visible area 210 and a press input 591 regarding specific content (for example, image 516), the processor 120 may extend a user interface (for example, user interface 501) with reference to the specific content (for example, image 516) indicated by the press input 591, and may display the extended user interface (for example, user interface 505) in a changed visible area 220.

In an embodiment, the processor 120 may display, in the visible area 220, a user interface 505 having a layout configured such that, among multiple images 551-556, the image 556 corresponding to the press input 591 is disposed with an extended size compared with the other images 551-555. In an embodiment, the image 556 may be an extended version of the image 516. In an embodiment, the images 551-555 may correspond to the images 511-515, respectively.

In an embodiment, the processor 120 may display, in the visible area 220, a user interface 505 extended to have a layout configured such that the width of the image 556 corresponding to the press input 591 corresponds to the width of the visible area 220. In an embodiment, the processor 120 may display, in the visible area 220, a user interface 505 extended to have a layout configured such that the image 556 corresponding to the press input 591 is positioned in a predesignated position in the area of the user interface 505 (for example, at the upper end of the user interface 505).

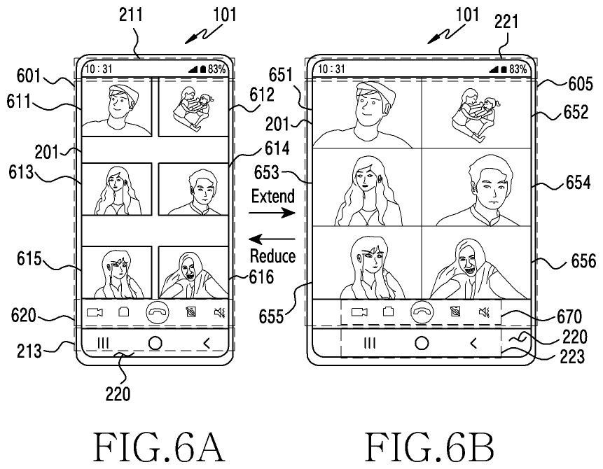

FIG. 6A is a diagram illustrating an example change in a user interface for a video call resulting from a change in a visible area of a display 201 of an electronic device 101 according to an embodiment, and FIG. 6B is a diagram illustrating an example change in a user interface for a video call resulting from a change in a visible area of a display 201 of an electronic device 101 according to an embodiment. FIG. 6A and FIG. 6B may be described with reference to the components in FIG. 1.

Referring to FIG. 6A, the display 201 may display user interfaces 211, 213, and 601 in a visible area 210. In an embodiment, the user interfaces 211, 213, and 601 in FIG. 6A may correspond to the user interfaces 211, 213, and 501 in FIG. 5A, respectively. Referring to FIG. 6A, the display 201 may be in an intermediate state.

Referring to FIG. 6B, the display 201 may display user interfaces 221, 223, and 605 corresponding to the size of the visible area 220. In an embodiment, the user interfaces 221, 223, and 605 may be user interfaces extended from the user interfaces 211, 213, and 601 respectively. In an embodiment, the user interfaces 221 and 223 in FIG. 6B may correspond to the user interfaces 221 and 223 in FIG. 5B, respectively. Referring to FIG. 6B, the display 201 may be in an unrolled state. However, this is only an example, and the display 201 in FIG. 6B may be in an intermediate state in which the same is unrolled slightly more than the display 201 in FIG. 6A.

In an embodiment, the electronic device 101 may display images to the user through user interfaces 601 and 605. In an embodiment, the user interfaces 601 and 605 may represent video call application execution screens. In an embodiment, the images displayed through the user interfaces 601 and 605 may be based on image data acquired through other electronic devices (for example, electronic devices 102 and 104).

In an embodiment, the user interfaces 601 and 605 may include bars 620 and 670 for manipulating the video call, respectively. In an embodiment, the bars 620 and 670 for manipulating the video call may include an icon for ending the video call.

In an embodiment, the user interface 601 may have a layout configured such that multiple images 611-616 are disposed with the same size. In an embodiment, each of the multiple images 611-616 may be displayed with a predesignated image size in the user interface 601.

In an embodiment, upon identifying a change in the visible area 210 with no press input regarding specific content, the processor 120 may extend a user interface (for example, user interface 601) and may display the extended user interface (for example, user interface 605) in a changed visible area 220.

In an embodiment, compared with the user interface 601, the user interface 605 may display the same number of images 651-656. In an embodiment, compared with the user interface 601, the user interface 605 may display images 651-656 extended in proportion to the size of the extended visible area 220.

In an embodiment, the user interface 605 may display multiple images 651-656 disposed with the same size. In an embodiment, the multiple images 651-656 may correspond to the multiple images 611-616, respectively.

Referring to FIG. 5A, FIG. 5B, FIG. 6A, and FIG. 6B, according to whether or not a press input 591 is identified while the visible area 210 is extended, the processor 120 may change the layout of the user interface 501 with reference to the content (for example, image 516) corresponding to the press input 591 or extend the user interface 601. In an embodiment, if a press input is identified while the visible area 210 is extended, the processor 120 may change the layout of the user interface 501 with reference to the content (for example, image 516) corresponding to the press input 591 and, if no press input is identified while the visible area 210 is extended, the processor 120 may extend the user interface 601.

Although FIG. 5A, FIG. 5B, FIG. 6A, and FIG. 6B illustrate an example change in a user interface according to whether or not a press input is identified while a visible area 210 is extended, this is only an example. In an embodiment, according to whether or not a press input is identified while the visible area 210 is reduced, the layout of the user interface may be changed, or the user interface may be reduced. In an embodiment, if a press input is identified while the visible area 220 is reduced, the processor 120 may change the layout of the user interface with reference to the content corresponding to the press input. In an embodiment, if no press input is identified while the visible area 220 is reduced, the processor 120 may reduce the user interface. In an embodiment, the operation of reducing the user interface may be the opposite of the operation of extending the user interface.

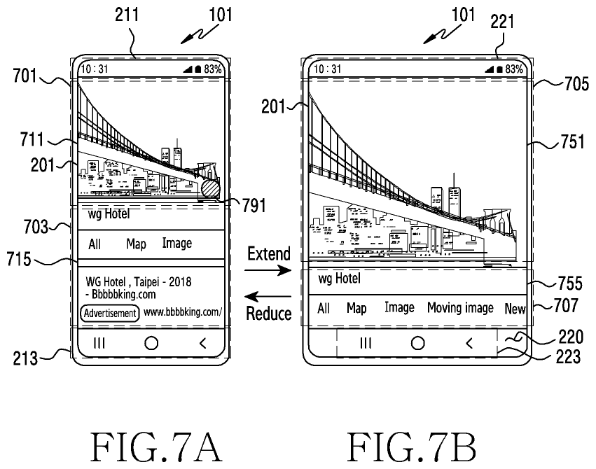

FIG. 7A is a diagram illustrating an example change in a user interface of applications resulting from extension of a visible area of a display 201 of an electronic device 101 according to an embodiment, and FIG. 7B is a diagram illustrating an example change in a user interface of applications resulting from extension of a visible area of a display 201 of an electronic device 101 according to an embodiment. FIG. 7A and FIG. 7B may be described with reference to the components in FIG. 1.

Referring to FIG. 7A, the display 201 may display user interfaces 211, 213, 701, and 703 in a visible area 210. In an embodiment, the user interfaces 211 and 213 in FIG. 7A may correspond to the user interfaces 211 and 213 in FIG. 3A, respectively. Referring to FIG. 7A, the display 201 may be in an intermediate state.

Referring to FIG. 7B, the display 201 may display user interfaces 221, 223, 705, and 707 corresponding to the size of the visible area 220. In an embodiment, the user interfaces 221 and 223 may be user interfaces extended from the user interfaces 211 and 213, respectively. In an embodiment, the user interface 705 and the user interface 701 may be execution screens of the same application. In an embodiment, the user interface 707 and the user interface 703 may be execution screens of the same application. In an embodiment, the user interfaces 221 and 223 in FIG. 7B may correspond to the user interfaces 221 and 223 in FIG. 3B, respectively. Referring to FIG. 7B, the display 201 may be in an unrolled state. However, this is only an example, and the display 201 in FIG. 7B may be in an intermediate state in which the same is unrolled slightly more than the display 201 in FIG. 7A.

In an embodiment, the electronic device 101 may display two or more application execution screens through the display 201. In an embodiment, the electronic device 101 may display an execution screen for a first application (for example, gallery application) through the user interface 701, and may display an execution screen for a second application (for example, Internet browsing application) through the user interface 703. In an embodiment, the user interface 701 may represent content (for example, picture 711). In an embodiment, the user interface 703 may represent a search result 715.

In an embodiment, the user interfaces 701 and 703 may be disposed through an area excluding the user interfaces 211 and 213 of the visible area 210 of the display 201. In an embodiment, the user interfaces 701 and 703 may have a uniform size. In an embodiment, the user interfaces 701 and 703 may be disposed on the upper and lower sides of the visible area 210 of the display 201, respectively. However, this is only an example, and the user interfaces 701 and 703 may have nonuniform sizes. In an embodiment, the user interfaces 701 and 703 may be disposed on the left and right sides of the visible area 210 of the display 201, respectively.

In an embodiment, the electronic device 101 may display content 711, based on the aspect ratio of the content 711, through the user interface 701. In an embodiment, by displaying the content 711 based on the aspect ratio of the content 711, the area deviating from the display area of the content 711 may be shaded in the user interface 701. In an embodiment, the shaded area may be positioned on at least one of the upper portion or the lower portion deviating from the display area of the content 711. In an embodiment, the shaded area may be positioned on at least one of the left portion or the right portion deviating from the display area of the content 711.

In an embodiment, upon identifying a change in the visible area 210 and a press input 791 regarding specific content (for example, picture 711), the processor 120 may extend a user interface (for example, user interface 701) with reference to the specific content (for example, picture 711) represented by the press input 791, and may display the extended user interface (for example, user interface 705) in a changed visible area 220.

In an embodiment, the processor 120 may display user interfaces 705 and 707 in the visible area 220 such that the user interface 705 including specific content (for example, picture 711) represented by a press input 791 occupies a larger area than the other user interface 707. In an embodiment, the processor 120 may extend the user interface 705 such that the specific content (for example, picture 711) represented by the press input 791 is extended according to the aspect ratio of the content 711. In an embodiment, as the user interface 705 is extended according to the aspect ratio of the content 711, no shaded area may exist in the user interface 705. In an embodiment, the picture 751 may be an extended image of the picture 711.

In an embodiment, the processor 120 may extend the user interface 707 in the direction of extension of the display 201 (for example, horizontal direction) and may reduce the same in the direction perpendicular to the direction of extension (for example, vertical direction). In an embodiment, as the user interface 707 is extended in the direction of extension of the display 201 and is reduced in the direction perpendicular to the direction of extension, some pieces of information (for example, “advertisement”) may be excluded from the search result 755, and other pieces of information (for example, “moving image” and “news”) may be included therein. In an embodiment, the search result 755 may correspond to the search result 715.

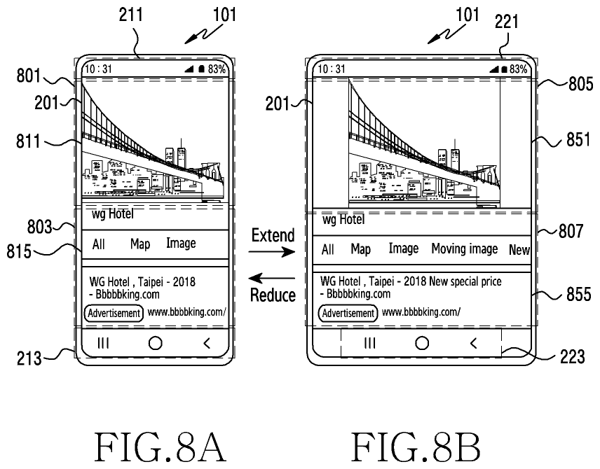

FIG. 8A is a diagram illustrating an example change in a user interface of applications resulting from extension of a visible area of a display 201 of an electronic device 101 according to an embodiment, and FIG. 8B is a diagram illustrating an example change in a user interface of applications resulting from extension of a visible area of a display 201 of an electronic device 101 according to an embodiment. FIG. 8A and FIG. 8B may be described with reference to the components in FIG. 1.

Referring to FIG. 8A, the display 201 may display user interfaces 211, 213, 801, and 803 in a visible area 210. In an embodiment, the user interfaces 211 and 213 in FIG. 8A may correspond to the user interfaces 211 and 213 in FIG. 3A, respectively. In embodiment, the user interfaces 801 and 803 in FIG. 8A may correspond to the user interfaces 701 and 703 in FIG. 7A, respectively. Referring to FIG. 8A, the display 201 may be in an intermediate state.

Referring to FIG. 8B, the display 201 may display user interfaces 221, 223, 805, and 807 corresponding to the size of the visible area 220. In an embodiment, the user interfaces 221 and 223 may be user interfaces extended from the user interfaces 211 and 213, respectively. In an embodiment, the user interface 805 and the user interface 801 may be execution screens of the same application. In an embodiment, the user interface 807 and the user interface 803 may be execution screens of the same application. In an embodiment, the user interfaces 221 and 223 in FIG. 8B may correspond to the user interfaces 221 and 223 in FIG. 3B, respectively. Referring to FIG. 8B, the display 201 may be in an unrolled state. However, this is only an example, and the display 201 in FIG. 8B may be in an intermediate state in which the same is unrolled slightly more than the display 201 in FIG. 8A.

In an embodiment, the electronic device 101 may display two or more application execution screens through the display 201. In an embodiment, the electronic device 101 may display an execution screen for a first application (for example, gallery application) through the user interface 801, and may display an execution screen for a second application (for example, Internet browsing application) through the user interface 803. In an embodiment, the user interface 801 may represent content (for example, picture 811). In an embodiment, the user interface 803 may represent a search result 815.

In an embodiment, the user interfaces 801 and 803 may be disposed through an area excluding the user interfaces 211 and 213 of the visible area 210 of the display 201. In an embodiment, the user interfaces 801 and 803 may have a uniform size. In an embodiment, the user interfaces 801 and 803 may be disposed on the upper and lower sides of the visible area 210 of the display 201, respectively. However, this is only an example, and the user interfaces 801 and 803 may have nonuniform sizes. In an embodiment, the user interfaces 801 and 803 may be disposed on the left and right sides of the visible area 210 of the display 201.

In an embodiment, upon identifying a change in the visible area 210 with no press input regarding specific content, the processor 120 may extend user interfaces (for example, user interfaces 801 and 803) and may display the extended user interfaces (for example, user interface 805 and 807) in a changed visible area 220.

In an embodiment, the user interface 805 may be, compared with the user interface 801, a user interface extended in the direction of extension of the display 201 (for example, horizontal direction). In an embodiment, as the user interface 805 is extended in the direction of extension, a shaded area may exist in at least one of the left portion or the right portion deviating from the display area of content (for example, picture 851).

In an embodiment, the user interface 807 may be, compared with the user interface 803, a user interface extended in the direction of extension of the display 201 (for example, horizontal direction). In an embodiment, as the user interface 807 is extended in the direction of extension, more pieces of information (for example, “moving image” and “news”) may be included in the search result 855.

Referring to FIG. 7A, FIG. 7B, FIG. 8A, and FIG. 8B, according to whether or not a press input 791 is identified while the visible area 210 is extended, the processor 120 may change the layout of the user interface 701 with reference to the content (for example, picture 711) corresponding to the press input 891, or may extend the user interface 801. In an embodiment, if a press input is identified while the visible area 210 is extended, the processor 120 may change the layout of the user interface 701 with reference to the content (for example, picture 711) corresponding to the press input 791 and, if no press input is identified while the visible area 210 is extended, may extend the user interface 801.

Although FIG. 7A, FIG. 7B, FIG. 8A, and FIG. 8B illustrate an example change in a user interface according to whether or not a press input is identified while a visible area 210 is extended, this is only an example. In an embodiment, according to whether or not a press input is identified while the visible area 210 is reduced, the layout of the user interface may be changed, or the user interface may be reduced. In an embodiment, if a press input is identified while the visible area 220 is reduced, the processor 120 may change the layout of the user interface with reference to the content corresponding to the press input. In an embodiment, if no press input is identified while the visible area 220 is reduced, the processor 120 may reduce the user interface. In an embodiment, the operation of reducing the user interface may be the opposite of the operation of extending the user interface.

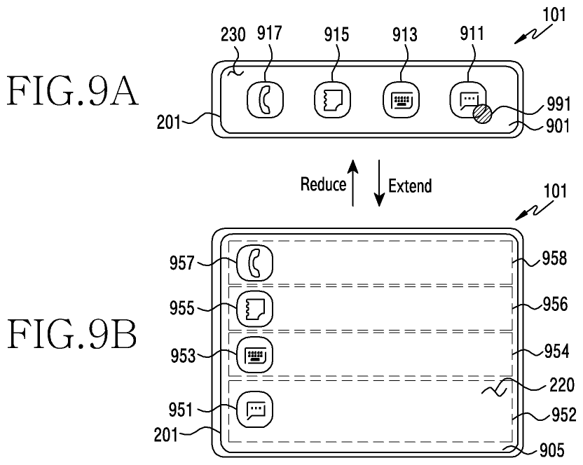

FIG. 9A is a diagram illustrating an example change in a user interface for a notification resulting from extension of a visible area of a display 201 of an electronic device 101 according to an embodiment, and FIG. 9B is a diagram illustrating an example change in a user interface for a notification resulting from extension of a visible area of a display 201 of an electronic device 101 according to an embodiment. FIG. 9A and FIG. 9B may illustrate an example state in which the user uses the electronic device 101 in the horizontal direction. FIG. 9A and FIG. 9B may be described with reference to FIG. 1.

Referring to FIG. 9A, the display 201 may display a user interface 901 in a visible area 230. In an embodiment, the user interface 901 may include icons 911-917 used by the electronic device 101 to indicate applications having existing notifications. Referring to FIG. 9A, the display 201 may be in a rolled state.

Referring to FIG. 9B, the display 201 may display a user interface 905 in a visible area 220. In an embodiment, the user interface 905 may include icons 951, 953, 955, and 957 for indicating applications having existing notifications, and areas 952, 954, 956, and 968 for indicating the content of notifications corresponding thereto. In an embodiment, the user interface 905 may be a user interface extended from the user interface 901. Referring to FIG. 9B, the display 201 may be in an unrolled state. However, this is only an example, and the display 201 in FIG. 9B may be in an intermediate state.

In an embodiment, upon identifying a change in the visible area 210 and a press input 991 regarding the icon 911, the processor 120 may extend a user interface (for example, user interface 901) with reference to the icon 911 indicated by the press input 991, and may display the extended user interface (for example, user interface 905) in a changed visible area 220.

In an embodiment, the processor 120 may display, in the visible area 220, a user interface 905 configured such that the area 952 for displaying the content of a notification corresponding to the icon 951 indicated by the press input 991 is larger than the other areas 954, 956, and 958. In an embodiment, the processor 120 may display the area 952 in the user interface 905 so as to display the entire content of the notification corresponding to the icon 951 indicated by the press input 991.

Although the area 952 is lower than the other areas 954, 956, and 958 in the example illustrated in FIG. 9A and FIG. 9B, this is only an example. In an embodiment, the area 952 may be positioned higher than the other areas 954, 956, and 958.

Although all areas 952, 954, 956, and 958 for displaying the content of notifications corresponding to the icons 951, 953, 955, and 957 are displayed in the example illustrated in FIG. 9A and FIG. 9B, this is only an example. In an embodiment, if the size of the content of the notification corresponding to the icon 951 exceeds, based on the press input 991, the visible area 220, the user interface 905 may display only an area 952 for displaying the content of the notification corresponding to the icon 951.

In an embodiment, if the visible area of the display 201 is extended, if the entire content of the notification corresponding to the icon 951 is accordingly displayed based on the press input 991, and if the visible area is still extended thereafter, the processor 120 may display the content of notifications corresponding to the other icons 953, 955, and 957 in a predesignated order.

In an embodiment, the processor 120 may display, in the visible area 230, a user interface 901 including only icons 911, 913, 915, and 917, and may display, in the visible area 220, a user interface 905 including icons 951, 953, 955, and 957 and areas 952, 954, 956, and 958 for displaying the content of notifications.

In an embodiment, the processor 120 may display the user interface 901 while the length of the display 201 along the direction of extension is equal to/smaller than a designated length, and may display the user interface 905 if the length of the display 201 along the direction of extension exceeds the designated length.

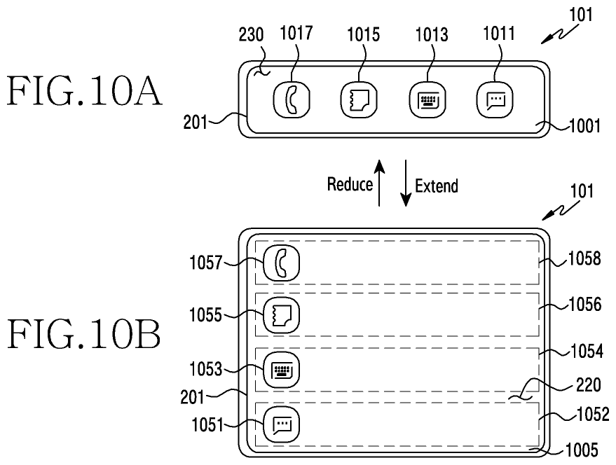

FIG. 10A is a diagram illustrating an example change in a user interface for a notification resulting from extension of a visible area of a display 201 of an electronic device 101 according to an embodiment, and FIG. 10B is a diagram illustrating an example change in a user interface for a notification resulting from extension of a visible area of a display 201 of an electronic device 101 according to an embodiment. FIG. 10A and FIG. 10B may illustrate an example state in which the user uses the electronic device 101 in the horizontal direction. FIG. 10A and FIG. 10B may be described with reference to FIG. 1.

Referring to FIG. 10A, the display 201 may display a user interface 1001 in a visible area 230. In an embodiment, the user interface 1001 may include icons 1011-1017 used by the electronic device 101 to indicate applications having existing notifications. In an embodiment, the user interface 1001 in FIG. 10A may correspond to the user interface 901 in FIG. 9A. Referring to FIG. 10A, the display 201 may be in a rolled state.

Referring to FIG10B, the display 201 may display a user interface 1005 in a visible area 220. Referring to FIG. 10B, the display 201 may be in an unrolled state. In an embodiment, the user interface 1005 may include icons 1051, 1053, 1055, and 1057 for indicating applications having existing notifications, and areas 1052, 1054, 1056, and 1058 for indicating the content of notifications corresponding thereto. In an embodiment, the user interface 1005 may be a user interface extended from the user interface 1001.

In an embodiment, upon identifying a change in the visible area 230 with no press input regarding specific content, the processor 120 may display, in the visible area 220, a user interface 1005 configured such that areas 1052, 1054, 1056, and 1058 for displaying the content of notifications corresponding to icons 1051, 1053, 1055, and 1057 have a uniform size.

Although areas 1052, 1054, 1056, and 1058 for displaying the content of notifications corresponding to icons 1051, 1053, 1055, and 1057 are displayed uniformly in the example illustrated in FIG. 10A and FIG. 10B, this is only an example. In an embodiment, the areas 1052, 1054, 1056, and 1058 may have different sizes according to the size of the content of the notifications corresponding to the icons 1051, 1053, 1055, and 1057.

In an embodiment, if the visible area of the display 201 is extended, the processor 120 may display the content of notifications corresponding to the icons 1051, 1053, 1055, and 1057 in a predesignated order.

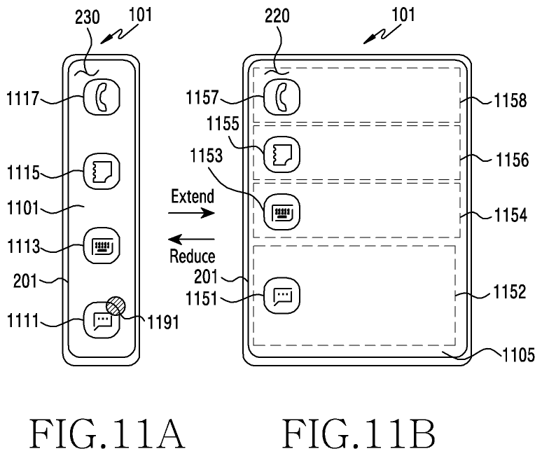

FIG. 11A is a diagram illustrating an example change in a user interface for a notification resulting from extension of a visible area of a display 201 of an electronic device 101 according to an embodiment, and FIG. 11B is a diagram illustrating an example change in a user interface for a notification resulting from extension of a visible area of a display 201 of an electronic device 101 according to an embodiment. FIG. 11A and FIG. 11B may illustrate an example state in which the user uses the electronic device 101 in the vertical direction. FIG. 11A and FIG. 11B may be described with reference to FIG. 1.

Referring to FIG. 11A, the display 201 may display a user interface 1101 in a visible area 230. In an embodiment, the user interface 1101 may include icons 1111-1117 used by the electronic device 101 to indicate applications having existing notifications. Referring to FIG. 11A, the display 201 may be in a rolled state.

Referring to FIG. 11B, the display 201 may display a user interface 1105 in a visible area 220. In an embodiment, the user interface 1105 may include icons 1151, 1153, 1155, and 1157 for indicating applications having existing notifications, and areas 1152, 1154, 1156, and 1158 for indicating the content of notifications corresponding thereto. In an embodiment, the user interface 1105 may be a user interface extended from the user interface 1101. Referring to FIG. 11B, the display 201 may be in an unrolled state.

In an embodiment, upon identifying a change in the visible area 230 with no press input regarding specific content, the processor 120 may display, in the visible area 220, a user interface 1105 configured such that areas 1152, 1154, 1156, and 1158 for displaying the content of notifications corresponding to icons 1151, 1153, 1155, and 1157 have a uniform size.

Although areas 1152, 1154, 1156, and 1158 for displaying the content of notifications corresponding to icons 1151, 1153, 1155, and 1157 are displayed uniformly in the example illustrated in FIG. 11A and FIG. 11B, this is only an example. In an embodiment, the areas 1152, 1154, 1156, and 1158 may have different sizes according to the size of the content of the notifications corresponding to the icons 1151, 1153, 1155, and 1157.

In an embodiment, if the visible area of the display 201 is extended, the processor 120 may display the content of notifications corresponding to the icons 1151, 1153, 1155, and 1157 in a predesignated order.

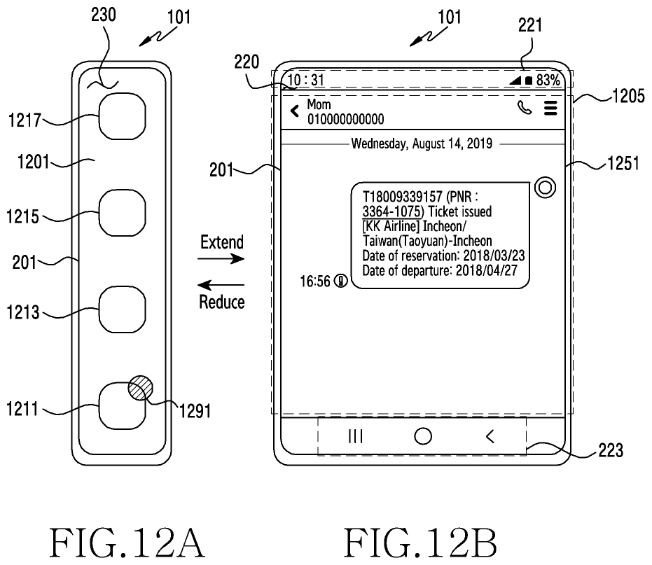

FIG. 12A is a diagram illustrating an example of switching of a screen resulting from extension of a visible area of a display 201 of an electronic device 101 according to an embodiment, and FIG. 12B is a diagram illustrating an example of switching of a screen resulting from extension of a visible area of a display 201 of an electronic device 101 according to an embodiment. FIG. 12A and FIG. 12B may illustrate an example state in which the user uses the electronic device 101 in the vertical direction. FIG. 12A and FIG. 12B may be described with reference to FIG. 1.

Referring to FIG. 12A, the display 201 may display a user interface 1201 in a visible area 230. In an embodiment, the user interface 1201 may include icons 1211-1217 used by the electronic device 101 to indicate applications having existing notifications. Referring to FIG. 12A, the display 201 may be in a rolled state.

Referring to FIG. 12B, the display 201 may display user interfaces 221, 223, and 1205 in a visible area 220. In an embodiment, the user interfaces 221 and 223 in FIG. 12B may correspond to the user interfaces 221 and 223 in FIG. 3B, respectively. In an embodiment, the user interface 1205 may include an application execution screen 1251 for displaying the content of a notification. Referring to FIG. 12B, the display 201 may be in an unrolled state. However, this is only an example, and the display 201 in FIG. 12B may be in an intermediate state.

In an embodiment, upon identifying a change in the visible area 230 and a press input 1291 regarding the icon 1211, the processor 120 may execute an application corresponding to the icon 1211 represented by the press input 1291. In an embodiment, upon identifying a change in the visible area 230 and a press input 1211 regarding the icon 1211, the processor 120 may display the result of executing the application corresponding to the icon 1211 through the user interface 1205. In an embodiment, the result of executing the application may be a screen for displaying the content of the notification corresponding to the icon 1211.

In an embodiment, upon identifying a change in the visible area 230 and a press input 1291 regarding the icon 1211, the processor 120 may request the user to conduct a user authentication. In an embodiment, if the user authentication succeeds, the processor 120 may display the result of executing the application corresponding to the icon 1211 represented by the press input 1291 through the user interface 1205.

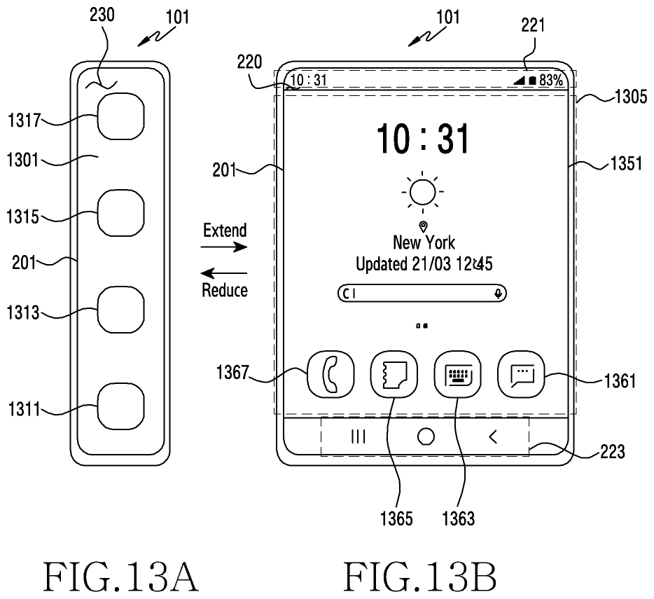

FIG. 13A is a diagram illustrating an example of switching of a screen resulting from extension of a visible area of a display 201 of an electronic device 101 according to an embodiment, and FIG. 13B is a diagram illustrating an example of switching of a screen resulting from extension of a visible area of a display 201 of an electronic device 101 according to an embodiment. FIG. 13A and FIG. 13B may illustrate an example state in which the user uses the electronic device 101 in the vertical direction. FIG. 13A and FIG. 13B may be described with reference to FIG. 1.

Referring to FIG. 13A, the display 201 may display a user interface 1301 in a visible area 230. In an embodiment, the user interface 1301 may include icons 1311-1317 used by the electronic device 101 to indicate applications having existing notifications. Referring to FIG. 13A, the display 201 may be in a rolled state.

Referring to FIG. 13B, the display 201 may display user interfaces 221, 223, and 1305 in a visible area 220. In an embodiment, the user interfaces 221 and 223 in FIG. 13B may correspond to the user interfaces 221 and 223 in FIG. 3B, respectively. In an embodiment, the user interface 1305 may include an application execution screen 1351 for displaying the content of a notification. Referring to FIG. 13B, the display 201 may be in an unrolled state. However, this is only an example, and the display 201 in FIG. 13B may be in an intermediate state.

In an embodiment, if a change in the visible area 230 is identified with no press input regarding a specific icon, the processor 120 may display a user interface 1305 representing a home screen 1351.

In an embodiment, if a change in the visible area 230 is identified with no press input regarding a specific icon, the processor 120 may request the user to conduct a user authentication. In an embodiment, if the user authentication succeeds, the processor 120 may display a user interface 1305 representing a home screen 1351. In an embodiment, the user authentication may be based on a user input made by the user (for example, touch input for fingerprint authentication).

Referring to FIG. 12A, FIG. 12B, FIG. 13A, and FIG. 13B, according to whether or not a press input 1291 is identified while the visible area 230 is extended, the processor 120 may display an execution screen 1251 for the application represented by the icon 1211 corresponding to the press input 1291, or may display a predesignated screen (for example, home screen 1351). In an embodiment, if a press input is identified while the visible area 230 is extended, the processor 120 may display the execution screen 1251 for the application represented by the icon 1211 corresponding to the press input 1291, and if no press input is identified while the visible area 230 is extended, may display the predesignated screen (for example, home screen 1351).

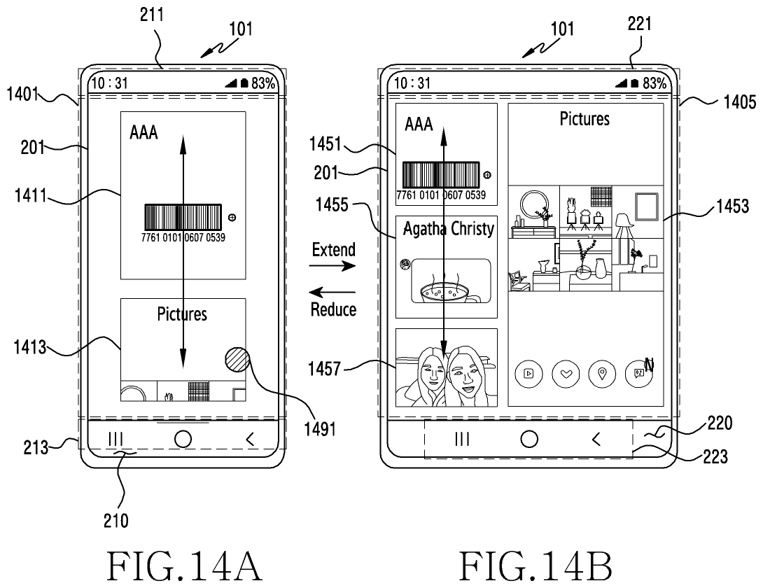

FIG. 14A is a diagram illustrating an example change in the recent home screen resulting from extension of a visible area of a display 201 of an electronic device 101 according to an embodiment, and FIG. 14B is a diagram illustrating an example change in the recent home screen resulting from extension of a visible area of a display 201 of an electronic device 101 according to an embodiment. FIG. 14A and FIG. 14B may illustrate an example state in which the user uses the electronic device 101 in the vertical direction. FIG. 14A and FIG. 14B may be described with reference to the components in FIG. 1.

Referring to FIG. 14A, the display 201 may display user interfaces 211, 213, and 1401 in a visible area 210. In an embodiment, the user interfaces 211 and 213 in FIG. 14A may correspond to the user interfaces 211 and 213 in FIG. 3A. In an embodiment, the user interface 1401 may include execution screens 1411 and 1413 for representing applications recently executed by the electronic device 101. In an embodiment, the execution screen 1413 may represent a state in which a part of the entire execution screen is not displayed according to the size of the display 201. In an embodiment, the user interface 1401 may enable scrolling of execution screens for representing recently executed applications through a user input (for example, drag). The display 201 in FIG. 14A may be in an intermediate state.

Referring to FIG. 14B, the display 201 may display user interfaces 221, 223, and 1405 in a visible area 220. In an embodiment, the user interfaces 221 and 223 in FIG. 14B may correspond to the user interfaces 221 and 223 in FIG. 3B. In an embodiment, the user interface 1405 may include execution screens 1451-1457 for representing recently executed applications. Referring to FIG. 14B, the display 201 may be in an unrolled state. However, this is only an example, and the display 201 in FIG. 14B may be in an intermediate state in which the same is unrolled slightly more than the display 201 in FIG. 14A.

In an embodiment, upon identifying a change in the visible area 210 and a press input 1491, the processor 140 may display a user interface 1405 configured such that the execution screen 1453 represented by the press input 1491 is extended. In an embodiment, upon identifying a change in the visible area 210 and a press input 1491, the processor 140 may display a user interface 1405 configured such that the execution screen 1453 represented by the press input 1491 is larger than the other execution screens 1451, 1455, and 1457. In an embodiment, the user interface 1405 enable scrolling of execution screens 1451, 1455, and 1457 through a user input (for example, drag).

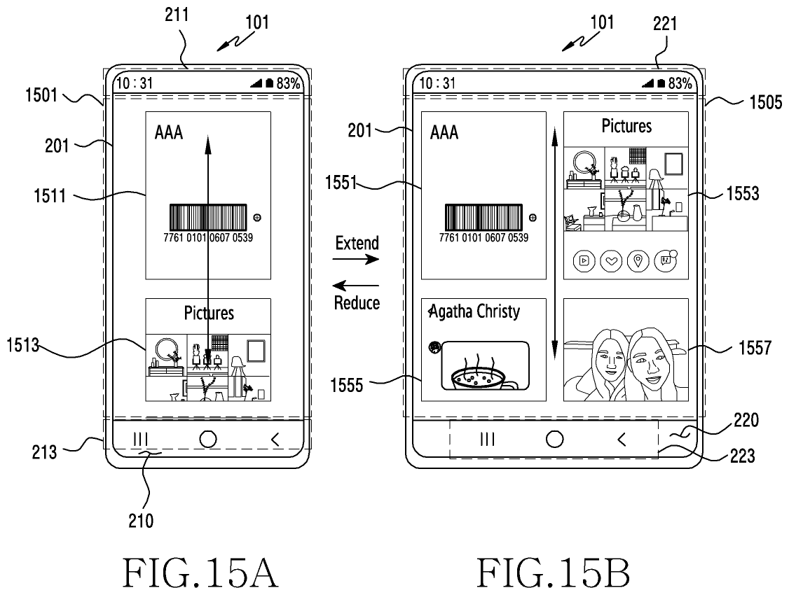

FIG. 15A is a diagram illustrating an example change in the recent home screen resulting from extension of a visible area of a display 201 of an electronic device 101 according to an embodiment, and FIG. 15B is a diagram illustrating an example change in the recent home screen resulting from extension of a visible area of a display 201 of an electronic device 101 according to an embodiment. FIG. 15A and FIG. 15B may illustrate an example state in which the user uses the electronic device 101 in the vertical direction. FIG. 15A and FIG. 15B may be described with reference to the components in FIG. 1.

Referring to FIG. 15A, the display 201 may display a user interface 1501 in a visible area 210. In an embodiment, the user interfaces 211 and 213 in FIG. 15A may correspond to the user interfaces 211 and 213 in FIG. 3A, respectively. In an embodiment, the user interface 1501 may include execution screens 1511 and 1513 for representing applications recently executed by the electronic device 101. In an embodiment, the execution screen 1513 may represent a state in which a part of the entire execution screen is not displayed according to the size of the display 201. In an embodiment, the user interface 1501 may enable scrolling of execution screens for representing recently executed applications through a user input (for example, drag). The display 201 in FIG. 15A may be in an intermediate state.

Referring to FIG. 15B, the display 201 may display user interfaces 221, 223, and 1505 in a visible area 220. In an embodiment, the user interfaces 221 and 223 in FIG. 15B may correspond to the user interfaces 221 and 223 in FIG. 3B. In an embodiment, the user interface 1505 may include execution screens 1551-1557 for representing recently executed applications. Referring to FIG. 15B, the display 201 may be in an unrolled state. However, this is only an example, and the display 201 in FIG. 15B may be in an intermediate state in which the same is unrolled slightly more than the display 201 in FIG. 15A.

In an embodiment, upon identifying a change in the visible area 210 with no press input regarding a specific icon, the processor 120 may display a user interface 1305 including execution screens 1551-1557. In an embodiment, the user interface 1305 may further include, compared with the user interface 1301, a line of execution screens.

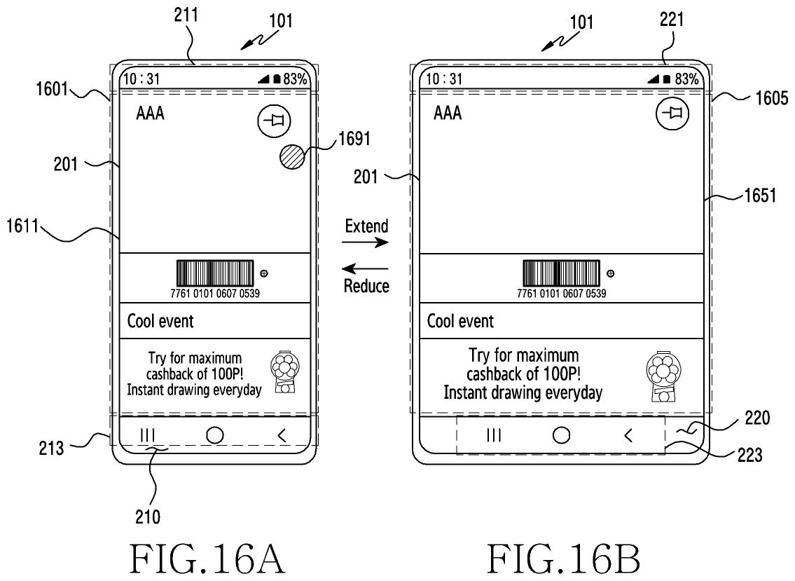

FIG. 16A is a diagram illustrating an example change in application execution screens resulting from extension of a visible area of a display 201 of an electronic device 101 according to an embodiment, and FIG. 16B is a diagram illustrating an example change in application execution screens resulting from extension of a visible area of a display 201 of an electronic device 101 according to an embodiment. FIG. 16A and FIG. 16B may illustrate an example state in which the user uses the electronic device 101 in the vertical direction. FIG. 16A and FIG. 16B may be described with reference to the components in FIG. 1.

Referring to FIG. 16A, the display 201 may display user interfaces 211, 213, and 1601 in a visible area 210. In an embodiment, the user interfaces 211 and 213 in FIG. 16A may correspond to the user interfaces 211 and 213 in FIG. 3A, respectively. In an embodiment, the user interface 1601 may include an execution screen 1611 for representing an application currently executed by the electronic device 101. The display 201 in FIG. 16A may be in an intermediate state.

Referring to FIG. 16B, the display 201 may display user interfaces 221, 223, and 1605 in a visible area 220. In an embodiment, the user interfaces 221 and 223 in FIG. 16B may correspond to the user interfaces 221 and 223 in FIG. 3B. In an embodiment, the user interface 1605 may include an execution screen 1651 for representing an application currently executed by the electronic device 101. Referring to FIG. 16B, the display 201 may be in an unrolled state. However, this is only an example, and the display 201 in FIG. 16B may be in an intermediate state in which the same is unrolled more than the display 201 in FIG. 16A.

In an embodiment, upon identifying a change in the visible area 210 and a press input 1691, the processor 160 may display a user interface 1605 configured such that the execution screen 1611 for the application represented by the press input 1691 is extended. In an embodiment, the user interface 1605 may include an execution screen 1651 which is an extension of the application execution screen 1611.

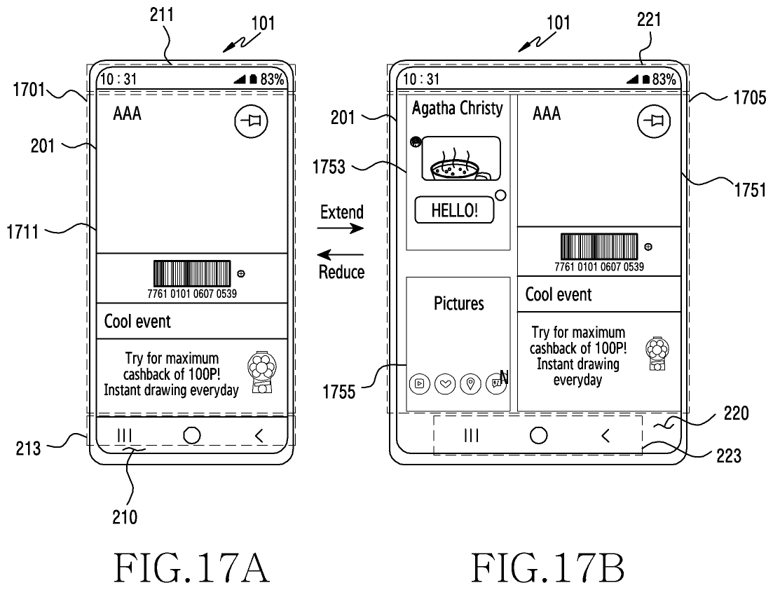

FIG. 17A is a diagram illustrating an example change in application execution screens resulting from extension of a visible area of a display 201 of an electronic device 101 according to an embodiment, and FIG. 17B is a diagram illustrating an example change in application execution screens resulting from extension of a visible area of a display 201 of an electronic device 101 according to an embodiment. FIG. 17A and FIG. 17B may illustrate an example state in which the user uses the electronic device 101 in the vertical direction. FIG. 17A and FIG. 17B may be described with reference to the components in FIG. 1.

Referring to FIG. 17A, the display 201 may display user interfaces 211, 213, and 1701 in a visible area 210. In an embodiment, the user interfaces 211 and 213 in FIG. 17A may correspond to the user interfaces 211 and 213 in FIG. 3A, respectively. In an embodiment, the user interface 1701 may include an execution screen 1711 for representing an application currently executed by the electronic device 101. The display 201 in FIG. 17A may be in an intermediate state.

Referring to FIG. 17B, the display 201 may display user interfaces 221, 223, and 1705 in a visible area 220. In an embodiment, the user interfaces 221 and 223 in FIG. 17B may correspond to the user interfaces 221 and 223 in FIG. 3B, respectively. In an embodiment, the user interface 1705 may include execution screens 1751-1755 for representing currently executed applications. Referring to FIG. 17B, the display 201 may be in an unrolled state. However, this is only an example, and the display 201 in FIG. 17B may be in an intermediate state in which the same is unrolled more than the display 201 in FIG. 17A.

In an embodiment, upon identifying a change in the visible area 230 with no press input, the processor 120 may display a user interface 1705 including execution screens 1751-1755. In an embodiment, upon identifying a change in the visible area 230 with no press input, the processor 120 may execute applications predesignated with regard to the application corresponding to the execution screen 1711. In an embodiment, the processor 120 may display execution screens 1753 and 7155 for executing the predesignated applications, together with the execution screen 1751, through the user interface 1705. In an embodiment, the predesignated applications may be selected from recently executed applications.

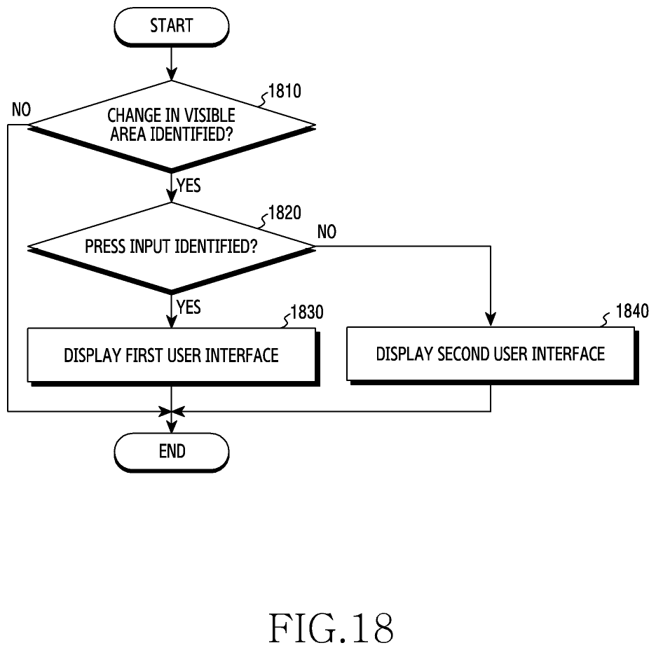

FIG. 18 is a flowchart illustrating example operations of an electronic device 101 according to an embodiment. FIG. 18 may be described with reference to the components in FIG. 1.

Referring to FIG. 18, in operation 1810, the processor 120 of the electronic device 101 may identify (determine whether there is) a change in a visible area of a display device 160. In an embodiment, the processor 120 may identify a change in the visible area of the display device 160, based on data from a sensor module 176 (for example, Hall sensor).

Referring to FIG. 18, if a change in the visible area of the display device 160 is identified (“Yes” in operation 1810), the processor 120 may perform operation 1820. Referring to FIG. 18, if no change in the visible area of the display device 160 is identified (“No” in operation 1810), the processor 120 may end the operations according to FIG. 18.

Referring to FIG. 18, in operation 1820, the processor 120 may identify a press input through the display device 160.

Referring to FIG. 18, if a press input is identified through the display device 160 (“Yes” in operation 1820), the processor 120 may perform operation 1830. Referring to FIG. 18, if no press input is identified through the display device 160 (“No” in operation 1820), the processor 120 may perform operation 1840.

Referring to FIG. 18, in operation 1830, the processor 120 may display a first user interface through the display device 160. In an embodiment, the processor 120 may display a first user interface configured such that an object represented by the identified press input has an extended size compared with the other objects.

Referring to FIG. 18, in operation 1840, the processor 120 may display a second user interface through the display device 160. In an embodiment, the processor 120 may display a second interface configured such that objects have a uniform size.

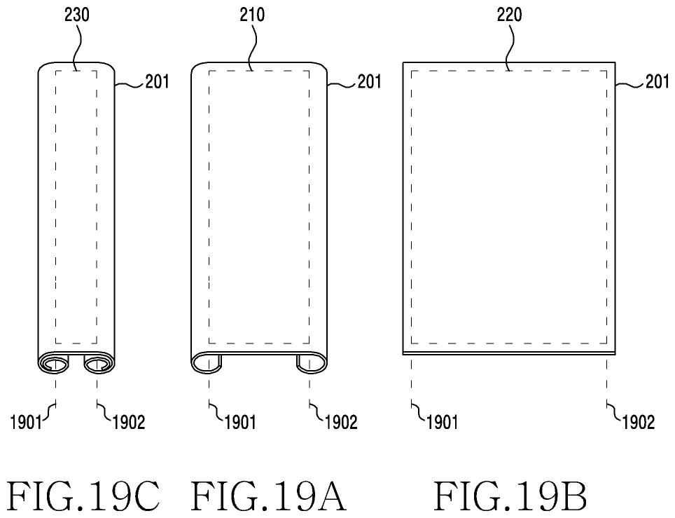

FIG. 19A is a diagram illustrating an example change following the degree of unrolling of a display 201 of an electronic device (for example, electronic device 101 in FIG. 1) according to an embodiment, FIG. 19B is a diagram illustrating an example change following the degree of unrolling of a display 201 of an electronic device (for example, electronic device 101 in FIG. 1) according to an embodiment, and FIG. 19C is a diagram illustrating an example change following the degree of unrolling of a display 201 of an electronic device (for example, electronic device 101 in FIG. 1) according to an embodiment. In an embodiment, the display 201 of the electronic device 101 in FIG. 19A, 19B and 19C (which may be referred to hereinafter as FIG. 19A to FIG. 19C for convenience) may be a rollable display having two rolling axes 1901 and 1902. In an embodiment, the display 201 of the electronic device 101 in FIG. 19A to FIG. 19C may correspond to the display 201 of the electronic device 101 in FIG. 2A to FIG. 2C.

Referring to FIG. 19A to FIG. 19C, the display 201 may have rolling axes 1901 and 1092 on the left and right parts thereof, respectively. Referring to FIG. 19A to FIG. 19C, the display 201 may be rolled using the two rolling axes 1901 and 1902 on the left and right parts thereof, respectively. However, although the display 201 has two rolling axes 1901 and 1092 on the left and right parts thereof, respectively, in the example illustrated in FIG. 19A to FIG. 19C, this is only an example. In an embodiment, it may be recognized that, according to the state in which the electronic device 101 is used (for example, vertical state or horizontal state), the display 201 has two rolling axes existing on the upper and lower parts thereof, respectively. For example, it may be recognized that, if the display 201 in FIG. 19A to FIG. 19C is rotated by a predetermined angle (for example, 90°) in a predesignated direction (for example, clockwise) and then used, the display 201 has two rolling axes existing on the upper and lower parts thereof, respectively.

Referring to FIG. 19A to FIG. 19C, the visible areas 210-230 of the display 201 may be changed according to the degree of rolling of the display 201 around the rolling axes 1901 and 1902. Referring to FIG. 19A to FIG. 19C, the visible areas 210-230 of the display 201 may be extended as the left and right parts of the display 201 are unrolled from the two rolling axes 1901 and 1902. Referring to FIG. 19A to FIG. 19C, the visible areas 210-230 of the display 201 may be reduced as the left and right parts of the display 201 are rolled around the two rolling axes 1901 and 1902.

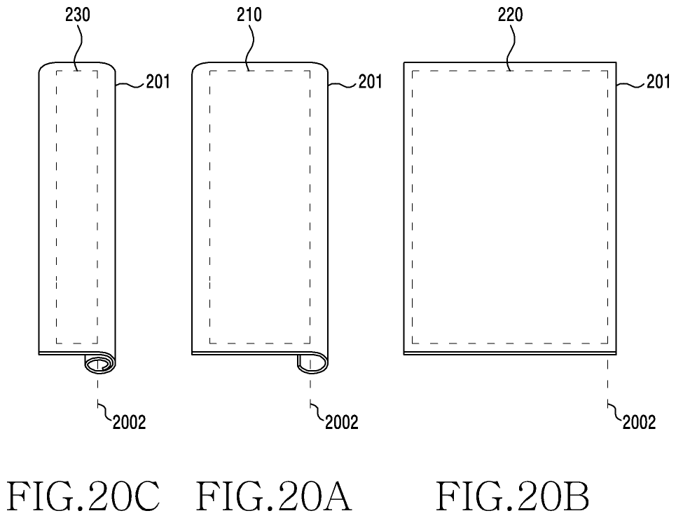

FIG. 20A is a diagram illustrating an example change following the degree of unrolling of a display 201 of an electronic device (for example, electronic device 101 in FIG. 1) according to an embodiment, FIG. 20B is a diagram illustrating an example change following the degree of unrolling of a display 201 of an electronic device (for example, electronic device 101 in FIG. 1) according to an embodiment, and FIG. 20C is a diagram illustrating an example change following the degree of unrolling of a display 201 of an electronic device (for example, electronic device 101 in FIG. 1) according to an embodiment. In an embodiment, the display 201 of the electronic device 101 in FIGS. 20A, 20B and 20C (which may be referred to hereinafter as FIG. 20A to FIG. 20C for convenience) may be a rollable display having one rolling axis 2002. In an embodiment, the display 201 of the electronic device 101 in FIG. 20A to FIG. 20C may correspond to the display 201 of the electronic device 101 in FIG. 2A to FIG. 2C.

Referring to FIG. 20A to FIG. 20C, the display 201 may have a rolling axis 2002 on the right part thereof. Referring to FIG. 20A to FIG. 20C, the display 201 may be rolled using the rolling axis 2002 on the right part thereof. However, although the display 201 has a rolling axis 2002 on the right side thereof in the example illustrated in FIG. 20A to FIG. 20C, this is only an example. In an embodiment, it may be recognized that, according to the state in which the electronic device 101 is used (for example, vertical state or horizontal state), the display 201 has a rolling axis on the left part, upper part, or lower part thereof. For example, it may be recognized that, if the display 201 in FIG. 20A to FIG. 20C is rotated by a predetermined angle (for example, 90°) in a predesignated direction (for example, clockwise) and then used, the display 201 has a rolling axis on the lower part thereof.

Referring to FIG. 20A to FIG. 20C, the visible areas 210-230 of the display 201 may be changed according to the degree of rolling of the display 201 around the rolling axis 2002. Referring to FIG. 20A to FIG. 20C, the visible areas 210-230 of the display 201 may be extended as the right part of the display 201 is unrolled from the rolling axis 2002. Referring to FIG. 20A to FIG. 20C, the visible areas 210-230 of the display 201 may be reduced as the right part of the display 201 is rolled around the rolling axis 2002.

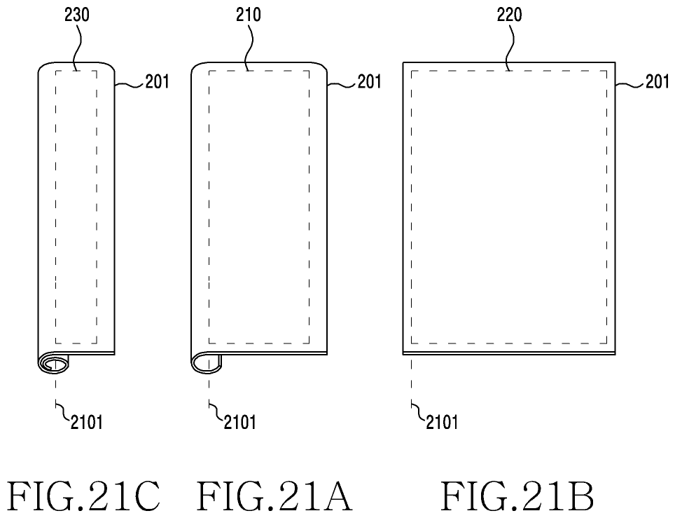

FIG. 21A is a diagram illustrating an example change following the degree of unrolling of a display 201 of an electronic device (for example, electronic device 101 in FIG. 1) according to an embodiment, FIG. 21B is a diagram illustrating an example change following the degree of unrolling of a display 201 of an electronic device (for example, electronic device 101 in FIG. 1) according to an embodiment, and FIG. 21C is a diagram illustrating an example change following the degree of unrolling of a display 201 of an electronic device (for example, electronic device 101 in FIG. 1) according to an embodiment. In an embodiment, the display 201 of the electronic device 101 in FIGS. 21A, 21B and 21C (which may be referred to hereinafter as FIG. 21A to FIG. 21C for convenience) may be a rollable display having one rolling axis 2101. In an embodiment, the display 201 of the electronic device 101 in FIG. 21A to FIG. 21C may correspond to the display 201 of the electronic device 101 in FIG. 2A to FIG. 2C.

Referring to FIG. 21A to FIG. 21C, the display 201 may have a rolling axis 2101 on the left part thereof. Referring to FIG. 21A to FIG. 21C, the display 201 may be rolled using the rolling axis 2101 on the left part thereof. However, although the display 201 has a rolling axis 2101 on the left side thereof in the example illustrated in FIG. 21A to FIG. 21C, this is only an example. In an embodiment, it may be recognized that, according to the state in which the electronic device 101 is used (for example, vertical state or horizontal state), the display 201 has a rolling axis on the right part, upper part, or lower part thereof. For example, it may be recognized that, if the display 201 in FIG. 21A to FIG. 21C is rotated by a predetermined angle (for example, 90°) in a predesignated direction (for example, clockwise) and then used, the display 201 has a rolling axis on the upper part thereof.

Referring to FIG. 21A to FIG. 21C, the visible areas 210-230 of the display 201 may be changed according to the degree of rolling of the display 201 around the rolling axis 2101. Referring to FIG. 21A to FIG. 21C, the visible areas 210-230 of the display 201 may be extended as the left part of the display 201 is unrolled from the rolling axis 2101. Referring to FIG. 21A to FIG. 21C, the visible areas 210-230 of the display 201 may be reduced as the left part of the display 201 is rolled around the rolling axis 2101.

Although FIG. 19A to FIG. 21C illustrate example cases in which a designated number of rolling axes (for example, one or two) exist, these are only examples. In an embodiment, the electronic device (for example, electronic device 101 in FIG. 1) may include three or more rolling axes.

As described above, the electronic device 101 may provide a user interface conforming to the user's intent by differently changing the user interface in view of the user's interaction (for example, user's press input) when the display 201 is extended or reduced.

As described above, according to an example embodiment, an electronic device may include: a flexible display; at least one sensor; a processor; and a memory operatively coupled to the flexible display, the at least one sensor, and the processor. The memory may store instructions that, when executed, cause the processor to control the electronic device to: display at least one content in a visible area among display areas of the flexible display; identify an input regarding a first content of the at least one content based on the visible area of the flexible display being changed using the at least one sensor; and change a layout regarding the first content identified by the input in the changed visible area of the flexible display in response to identifying the input.

In an example embodiment, the instructions may cause, when executed, the processor to change the layout regarding the first content by changing a size of the first content based on a rate of change in the visible area.

In an example embodiment, a first ratio between a first length of the first content in a first direction and a second length of the first content in a second direction, after the layout is changed may correspond to a second ratio between a third length of the first content in the first direction and a fourth length of the first content in the second direction, before the layout is changed.

In an example embodiment, the instructions may cause, when executed, the processor to change the layout regarding the first content by changing a size of the first content such that a first length of the first content in a first direction corresponds to a second length of the changed visible area of the flexible display in the first direction.

In an example embodiment, the instructions may cause, when executed, the processor to change the layout regarding the first content by positioning the first content at a designated location in the changed visible area.

In an example embodiment, the instructions may cause, when executed, the processor to change the layout regarding the first content by changing a type of the first content.

In an example embodiment, the instructions may cause, when executed, the processor to control the electronic device to: display the first content using a first user interface based on a length of the changed visible area of the flexible display in a second direction being equal to or less than a designated length; and display the first content using a second user interface having a type distinguished from the first user interface based on the length of the changed visible area of the flexible display in the second direction being greater than the designated length.

In an example embodiment, the instructions may cause, when executed, the processor to: authenticate a user of the electronic device based on identifying a different input; change the layout regarding the first content based on the user being authenticated; and display a designated screen in the changed visible area of the flexible display based on the user not being authenticated.

In an example embodiment, the instructions may cause, when executed, the processor to control the electronic device to: display the at least one content in a scrollable manner in the visible area before the visible area is changed; and in response to identifying the input, display the first content, the layout of which is changed, at a first location in the changed visible area of the flexible display, and display a second content other than the first content, of the at least one content, in a remaining area of the changed visible area of the flexible display in a scrollable manner.

In an example embodiment, the instructions may cause, when executed, the processor to change a layout regarding the at least one content in the changed visible area of the flexible display, based on the input regarding the first content not being identified while the visible area of the flexible display is changed.

According to an example embodiment, a method for operating an electronic device may include: displaying at least one content in a visible area among display areas of a flexible display of the electronic device; identifying an input regarding a first content of the at least one content, based on the visible area of the flexible display being changed, using at least one sensor of the electronic device; and changing a layout regarding the first content identified by the input, in the changed visible area of the flexible display, in response to identifying the input.

In an example embodiment, the changing the layout regarding the first content may include changing a size of the first content based on a rate of change in the visible area.

In an example embodiment, a first ratio between a first length of the first content in a first direction and a second length of the first content in a second direction, after the layout is changed, may correspond to a second ratio between a third length of the first content in the first direction and a fourth length of the first content in the second direction, before the layout is changed.

In an example embodiment, the changing the layout regarding the first content may include changing a size of the first content such that a first length of the first content in a first direction corresponds to a second length of the changed visible area of the flexible display in the first direction.

In an example embodiment, the changing the layout regarding the first content may include positioning the first content at a designated location in the changed visible area.

In an example embodiment, the changing the layout regarding the first content may include changing a type of the first content.

In an example embodiment, the changing the type of the first content may include: displaying the first content based on a length of the changed visible area of the flexible display in a second direction being equal to or less than a designated length; and displaying the first content, the type of which is changed, based on the length of the changed visible area of the flexible display being greater than the designated length.

In an example embodiment, the method may further include: authenticating a user of the electronic device, based on identifying a different input; changing the layout regarding the first content based on the user being authenticated; and displaying a designated screen in the changed visible area of the flexible display based on the user not being authenticated.

In an example embodiment, the changing the layout regarding the first content may include the: displaying the at least one content in a scrollable manner in the visible area before the visible area is changed; and in response to identifying the input, displaying the first content, the layout of which is changed, at a first location in the changed visible area of the flexible display, and displaying a second content other than the first content, of the at least one content, in a remaining area of the changed visible area of the flexible display in a scrollable manner.

In an example embodiment, the method may further include changing a layout regarding the at least one content in the changed visible area of the flexible display, based on the input regarding the first content not being identified while the visible area of the flexible display is changed.

While the disclosure has been illustrated and described with reference to various example embodiments, it will be understood that the various example embodiments are intended to be illustrative, not limiting. It will be further understood by one of ordinary skill in the art that various changes in form and detail may be made without departing from the true spirit and full scope of the disclosure, including the appended claims and their equivalents.

What is claimed is:

1. An electronic device comprising:
a flexible display;
at least one sensor;
a processor; and
a memory operatively coupled to the flexible display, the at least one sensor, and the processor,
wherein the memory is configured to store instructions that, when executed, cause the processor to control the electronic device to:
display at least one content in a visible area among display areas of the flexible display;
identify an input regarding a first content of the at least one content, based on the visible area of the flexible display being changed using the at least one sensor; and
change a layout regarding the first content identified by the input in the changed visible area of the flexible display in response to identifying the input.

2. The electronic device of claim 1, wherein the instructions are configured to cause, when executed, the processor to change the layout regarding the first content by changing a size of the first content based on a rate of change in the visible area.

3. The electronic device of claim 2, wherein a first ratio between a first length of the first content in a first direction and a second length of the first content in a second direction, after the layout is changed, corresponds to a second ratio between a third length of the first content in the first direction and a fourth length of the first content in the second direction, before the layout is changed.

4. The electronic device of claim 1, wherein the instructions are configured to cause, when executed, the processor to change the layout regarding the first content by changing a size of the first content such that a first length of the first content in a first direction corresponds to a second length of the changed visible area of the flexible display in the first direction.

5. The electronic device of claim 1, wherein the instructions are configured to cause, when executed, the processor to change the layout regarding the first content by positioning the first content at a designated location in the changed visible area.

6. The electronic device of claim 1, wherein the instructions are configured to cause, when executed, the processor to change the layout regarding the first content by changing a type of the first content.

7. The electronic device of claim 6, wherein the instructions are configured to cause, when executed, the processor to control the electronic device to:
display the first content using a first user interface based on a length of the changed visible area of the flexible display in a second direction being equal to or less than a designated length; and
display the first content using a second user interface having a type distinguished from the first user interface based on the length of the changed visible area of the flexible display in the second direction being greater than the designated length.

8. The electronic device of claim 1, wherein the instructions are configured to cause, when executed, the processor to:
authenticate a user of the electronic device based on identifying a different input;
change the layout regarding the first content based on the user being authenticated; and
display a designated screen in the changed visible area of the flexible display based on the user not being authenticated.

9. The electronic device of claim 1, wherein the instructions are configured to cause, when executed, the processor to control the electronic device to:
display the at least one content in a scrollable manner in the visible area before the visible area is changed; and
in response to identifying the input, display the first content, the layout of which is changed, at a first location in the changed visible area of the flexible display, and display a second content other than the first content, of the at least one content, in a remaining area of the changed visible area of the flexible display in a scrollable manner.

10. The electronic device of claim 1, wherein the instructions are configured to cause, when executed, the processor to change a layout regarding the at least one content in the changed visible area of the flexible display based on the input regarding the first content not being identified based on the visible area of the flexible display being changed.

11. A method for operating an electronic device, the method comprising:
displaying at least one content in a visible area among display areas of a flexible display of the electronic device;
identifying an input regarding a first content of the at least one content, based on the visible area of the flexible display being changed using at least one sensor of the electronic device; and
changing a layout regarding the first content identified by the input in the changed visible area of the flexible display in response to identifying the user input.

12. The method of claim 11, wherein the changing the layout regarding the first content comprises changing a size of the first content based on a rate of change in the visible area.

13. The method of claim 12, wherein a first ratio between a first length of the first content in a first direction and a second length of the first content in a second direction, after the layout is changed, corresponds to a second ratio between a third length of the first content in the first direction and a fourth length of the first content in the second direction, before the layout is changed.

14. The method of claim 11, wherein the changing the layout regarding the first content comprises changing a size of the first content such that a first length of the first content in a first direction corresponds to a second length of the changed visible area of the flexible display in the first direction.

15. The method of claim 11, wherein the changing the layout regarding the first content comprises positioning the first content at a designated location in the changed visible area.

16. The method of claim 11, wherein the changing the layout regarding the first content comprises changing a type of the first content.

17. The method of claim 16, wherein the changing the type of the first content comprises:
displaying the first content based on a length of the changed visible area of the flexible display in a second direction being equal to or less than a designated length; and
displaying the first content, the type of which is changed, based on the length of the changed visible area of the flexible display being greater than the designated length.

18. The method of claim 11, further comprising:
authenticating a user of the electronic device, based on identifying a different input;
changing the layout regarding the first content based on the user being authenticated; and
displaying a designated screen in the changed visible area of the flexible display based on the user not being authenticated.

19. The method of claim 11, wherein the changing the layout regarding the first content comprises:
displaying the at least one content in a scrollable manner in the visible area before the visible area is changed; and
in response to identifying the input, displaying the first content, the layout of which is changed, at a first location in the changed visible area of the flexible display, and displaying a second content other than the first content, of the at least one content, in a remaining area of the changed visible area of the flexible display in a scrollable manner.

20. The method of claim 11, further comprising changing a layout regarding the at least one content in the changed visible area of the flexible display based on the input regarding the first content not being identified based on the visible area of the flexible display being changed.
